(19) United States
(12) Patent Application Publication
(10) Pub. No.: US 2026/0048487 A1
(43) Pub. Date: Feb. 19, 2026

(54) RATCHET WRENCH HAVING DISC SPACER

(71) Applicant: Harbor Freight Tools USA, Inc., Calabasas, CA (US)

(72) Inventor: Oaty A. Frye, Middletown, CT (US)

(21) Appl. No.: 18/806,396

(22) Filed: Aug. 15, 2024

(51) Int. Cl. B25B 13/46

(52) U.S. Cl. CPC B25B 13/463

(57) ABSTRACT

According to embodiments, a ratchet tool includes: a head operably connected to a handle, the head including at least one cavity, wherein the at least one cavity receives and attaches to a cover plate; a ratchet gear including a drive member for transmitting torque to a work piece; a pawl disposed in the at least one cavity adjacent the ratchet gear, wherein the pawl is operable to engage with the ratchet gear in a first position to transmit torque through the ratchet gear and drive member in a first direction and a second position to transmit torque through the ratchet gear and drive member in a second direction; a selector switch disposed in the at least one cavity and configured to move the pawl between the first position and the second position; a spacer disposed in the at least one cavity; and a retaining clip configured to inhibit an vertical movement of the ratchet gear in the at least one cavity.

### CROSS REFERENCE TO RELATED APPLICATIONS

[Not Applicable]

### BACKGROUND

The present disclosure relates generally to ratchet tools. One exemplary ratchet tool is a ratchet, such as a ratchet that has selectable ratcheting functionality for both a clockwise and counterclockwise direction. Another exemplary ratchet tool is a ratcheting combination wrench, such as a ratcheting combination wrench with selectable ratcheting functionality for both a clockwise and counterclockwise direction. Such ratchet tools may be used in an automotive, shop, or construction environment when assembling or removing objects (e.g., tightening or untightening bolts or nuts).

### SUMMARY

According to embodiments, a ratchet tool includes: a head operably connected to a handle, the head including at least one cavity, wherein the at least one cavity receives and attaches to a cover plate; a ratchet gear including a drive member for transmitting torque to a work piece; a pawl disposed in the at least one cavity adjacent the ratchet gear, wherein the pawl is operable to engage with the ratchet gear in a first position to transmit torque through the ratchet gear and drive member in a first direction and a second position to transmit torque through the ratchet gear and drive member in a second direction; a selector switch disposed in the at least one cavity and configured to move the pawl between the first position and the second position; a spacer disposed in the at least one cavity; and a retaining clip configured to inhibit an vertical movement of the ratchet gear in the at least one cavity. The ratchet tool may include a sleeve body disposed in the at least one cavity adjacent the selector switch and configured to retain the selector switch while allowing for movement of the selector switch. The spacer may be arranged below the cover plate and above at least one of the sleeve body or the selector switch. The spacer may be arranged below the cover plate and above both the sleeve body and the selector switch. The retaining clip may be further configured to inhibit a vertical motion of the pawl. The retaining clip may increase a side load strength of the ratchet tool. The positioning of the retaining clip, the spacer, and the cover plate may increase a maximum torque deliverable through the ratchet tool. The retaining clip may maintain a position of the ratchet gear along a drive axis; the switch is configured to inhibit a vertical movement of the pawl; and the spacer may be configured to inhibit a vertical movement of the switch.

According to embodiments, a ratchet tool head assembly includes: a head body having first and second sides with a body cavity disposed in the first side, wherein the body cavity includes: a drive cavity portion, wherein the drive cavity portion is configured to receive a ratchet gear such that the ratchet gear is rotatably disposed in the drive cavity portion, the ratchet gear including a drive post extending vertically from the ratchet gear; an actuator cavity portion; and a groove disposed in a sidewall of the drive cavity portion proximate to and parallel with the first side; a retaining clip received by the groove, wherein the retaining clip is configured to inhibit a vertical movement of the ratchet gear, wherein the retaining clip includes a plurality of lug arms extending toward the actuator cavity portion; a spacer received by the actuator cavity portion and configured to retain an actuator within the actuator cavity portion; and a cover plate disposed on the first side of the head body, wherein the cover plate encloses the body cavity and includes an aperture, wherein the drive post of the ratchet gear projects vertically from the ratchet gear through the aperture. The retaining clip may increase a side load strength of the ratcheting tool head. The retaining clip may allow for increase of a torque delivered through the ratchet tool. The ratchet tool further may include a pawl disposed in a pawl cavity portion, the pawl being engageable with the ratchet gear to select a drive direction in which the ratchet gear rotates relative to the head body. The lug arms of the retaining clip may be configured to inhibit a vertical movement of the pawl.

According to embodiments, a method of assembling a ratchet tool includes: providing a ratchet tool head having a body cavity including a drive cavity portion and an actuator cavity portion; inserting an actuator operable to engage the ratchet gear, wherein the actuator is inserted into the actuator cavity portion; inserting a ratchet gear having a drive post into the drive cavity portion of the ratchet tool head; engaging a retaining clip into a groove disposed in a sidewall of the drive cavity portion to inhibit a vertical movement of the ratchet gear in the drive cavity portion, wherein the retaining clip includes lug arms extending toward the actuator cavity portion; placing a spacer above the actuator; and covering one or more of the body cavity, the drive cavity portion, or the actuator cavity portion with a cover plate, wherein the drive post projects outwardly from the ratchet gear through an aperture disposed in the cover plate, the retaining clip being disposed between a portion of the ratchet gear and the cover plate. The method may further include engaging the retaining clip including disposing an inner portion of the retaining clip on top of a shelf of the ratchet gear. The actuator may include a pawl and a switch, wherein the pawl is disposed between the ratchet gear and the switch; and the method may further comprise disposing the pawl below one or more of the lug arms of the retaining clip, and wherein the lug arms of the retaining clip may retain the pawl in a pawl cavity portion, and the pawl is adapted to be selectively engaged with the ratchet gear to select a drive direction in which torque is transmitted to a work piece. The switch may include a selector lever and the method further comprising disposing the selector lever on a bottom side of the ratchet tool head for a user to manipulate. The method may further include arranging the spacer and retaining clip to inhibit an vertical movement of one or both of the pawl or the switch.

### BRIEF DESCRIPTION OF SEVERAL VIEWS OF THE DRAWINGS

The following is a brief description of the drawings pertaining to the present disclosure, which will be discussed in more detail in the detailed description section below.

FIG. 1 illustrates a top perspective view of a ratchet tool, according to embodiments.

FIG. 2 illustrates a bottom perspective view of a portion of the ratchet tool, according to embodiments.

FIG. 3 illustrates a top perspective view of a portion of the ratchet tool, according to embodiments.

FIG. 4 illustrates an exploded view of a portion of the ratchet tool, according to embodiments.

FIG. 5A illustrates a front, top perspective view of the pawl, according to embodiments.

FIG. 5B illustrates a rear, bottom perspective view of the pawl, according to embodiments.

FIG. 6 illustrates a portion of the ratchet tool, according to embodiments.

FIG. 7 illustrates a cross-sectional view of a portion of the ratchet tool taken along the line 7-7 in FIG. 1, according to embodiments.

FIG. 8 illustrates a cross-sectional view of a portion of the ratchet tool taken along the line 8-8 in FIG. 1, according to embodiments.

FIG. 9 is a flowchart for a method of assembling a ratchet tool, according to embodiments.

The foregoing summary, as well as the following detailed description of certain features of the present application, are better understood when read in conjunction with the appended drawings. For the purposes of illustration, certain features are shown in the drawings. It should be understood, however, that the claims are not limited to the arrangements shown in the attached drawings. Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of applications comprising one or more embodiments of the disclosure. As such, the drawings are not meant to include all conventional features known by those of ordinary skill in the art to be required for the practice of the embodiments disclosed herein. Furthermore, the appearance shown in the drawings is one of many ornamental appearances that can be employed to achieve the stated functions of the system.

### DETAILED DESCRIPTION

A ratcheting tool may have a ratchet head that includes a retaining clip and/or bolted joint used to secure the ratchet assembly within the ratchet head. Retaining clips and bolt joints are resistant to loosening over time. Bolted joints require less precision to manufacture. A retaining clip, when manufactured out of specification may have substantially less holding force, which reduces the overall strength of the ratchet assembly. Ratcheting tools come in a variety of sizes in which the thickness and length of various components may differ. Having both the retaining clip and bolted joint, the bolted joint absorbs some load off the retaining clip, making machining less critical and the retaining clip reduces load on the bolted joint, reducing screw backout in the bolted joint. To accommodate for the variety of ratchet tool size differences, components are incorporated into the ratchet head to help stabilize the ratchet assembly by preventing unwanted movement. For example, a retaining clip and/or bolted joint may limit or prevent vertical movement of the ratchet assembly within the ratcheting tool. Vertical movement may cause parts of the ratchet assembly, such as the ratchet gear, pawl, and/or switch to come out of alignment. The misalignment of these parts, ratchet gear, pawl, and/or switch within the ratcheting tool, may cause the ratcheting tool to perform poorly or not at all. Additionally, the ratchet assembly experiencing undesirable vertical movement may cause the ratcheting tool to break or decrease the lifespan and/or effectiveness of the ratcheting tool. The retaining clip or bolted joint may be adequate to secure the ratchet assembly in place for standard length ratcheting tools or low torque applications. However, in ratcheting tools having longer handles, or being used with an added leveraging device, or being used in a higher torque application, undesirable degrees of side bending and twisting loads may occur. Side bending and twisting loads are forces that are not in the direction of loosening or tightening a fastener. Forces generated by these undesirable effects may cause the retaining clip and/or bolted joint can deform, loosen, or break.

In order to increase the strength of the ratcheting tool, particularly in limiting or preventing undesirable side bending and twisting loads, retaining clips and bolted joints may both be incorporated into the ratcheting tool. When a retaining clip and bolted joint are both included in the ratcheting tool, the plate of the bolted joint can be located between the retaining clip and the ratcheting mechanism. The ratcheting mechanism includes both the ratchet gear and the pawl. However, the thickness of the plate of the bolted joint may vary between different bolted joints. While it may be possible to fabricate bolted joints with plates having tighter thickness variations, such fabrication may incur undesirable expense. Further, a relatively large clearance between the retaining clip and the plate of the bolted joint may be required, which may tend to reduce the effective strength of combining both the retaining clip and plate.

Another option to increase the strength of the ratcheting tool is to place the retaining clip between the plate and the ratcheting mechanism and include a spacer. This method avoids the complications of accommodating for the plate thickness variations when the plate is located between the ratcheting mechanism and the retaining clip. However, having the retaining clip located between the plate and the ratcheting mechanism may cause portions of the ratcheting mechanism to shift and become misaligned, preventing the ratcheting mechanism to datum. To prevent misalignment from occurring and to permit the rachet mechanism to datum effectively, a spacer may be incorporated to prevent the ratchet mechanism from shifting. Additionally, components of the ratcheting mechanism, such as the pawl and ratchet gear, as well as a switch, are expensive to manufacture. Incorporating the spacer within the ratchet permits ratchet heads having varying thicknesses to accommodate the same pawls, ratchet gears, and switches. Manufacturers do not need to customize and manufacture the pawls, ratchet gears, and switches to accommodate each ratcheting tool having ratchet heads with varying thicknesses. Therefore, different sized ratchet heads may use some of the same sized/configured component, therefore decreasing manufacturing costs. Ratchet tools having both the retaining clip and the spacer are able to accommodate different size/thicknesses of ratchet heads without changing the more expensive components, such as the pawl and ratchet gear.

There is one issue with placing the retainer clip between the bolted plate and ratcheting mechanism. Which is the upper plane created by the bolted plate that datums all the ratcheting components is shifted. The retainer clip can position some of the critical to strength components such as the ratcheting gear and pawl, while a separate spacer is used to other not critical to strength components.

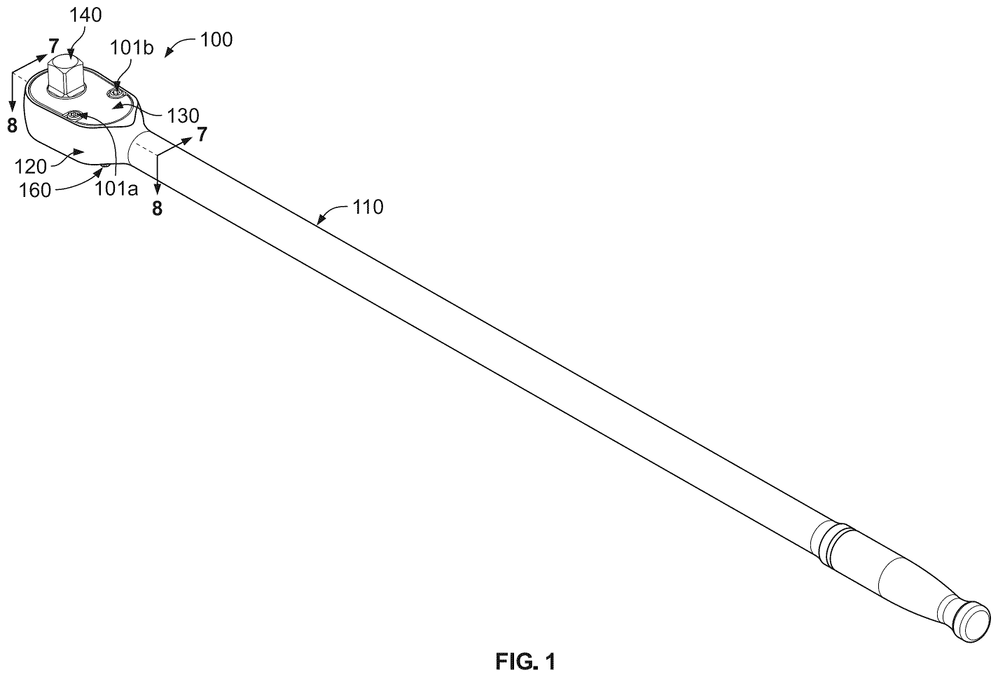

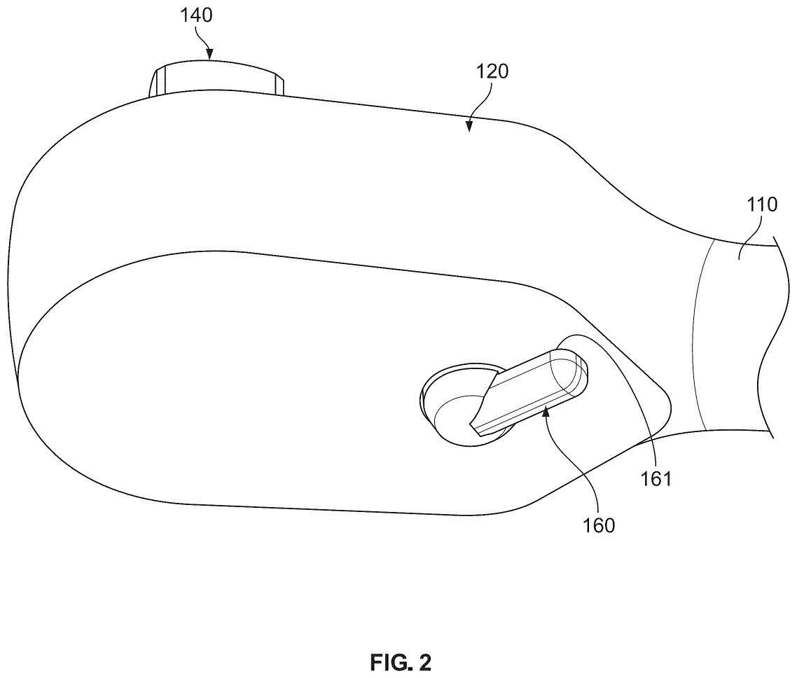

FIGS. 1 and 2 illustrate different views of an assembled ratchet tool 100, according to embodiments. Although the figures illustrate a ratchet tool 100 that is a ratchet, as will be understood, similar techniques may be used in a ratcheting combination wrench. FIG. 1 illustrates a top perspective view of the ratchet tool 100, according to embodiments. The ratchet tool 100 includes a handle 110, a head 120, a cover plate 130, a ratchet gear 140, a switch lever 161 (which is a feature of a switch 160 (or selector switch) and is shown in subsequent figures), and fasteners 101a, 101b (e.g., bolts). FIG. 2 illustrates a bottom perspective view of a portion of the ratchet tool 100, according to embodiments. The handle 110 is coupled or connected to the head 120 (e.g., the handle 110 and the head 120 are one integrated piece or may be separate pieces coupled to each other by a type of rotatable joint). As shown in FIG. 2, the switch 160 can be engaged by an user of the ratchet tool 100 to selectively switch the ratcheting direction of the ratchet tool 100 to clockwise (e.g., to tighten a bolt or nut) or to counterclockwise (e.g., to loosen a bolt or nut).

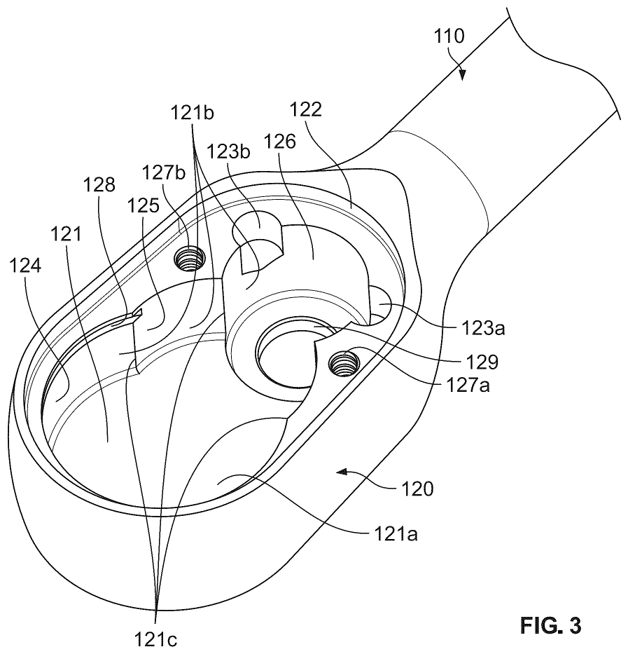

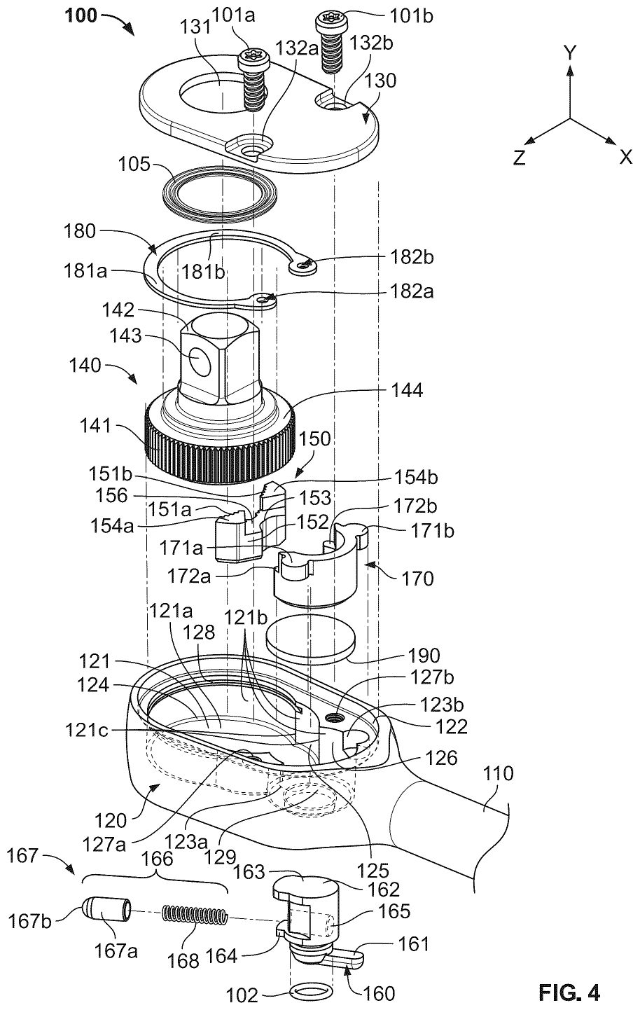

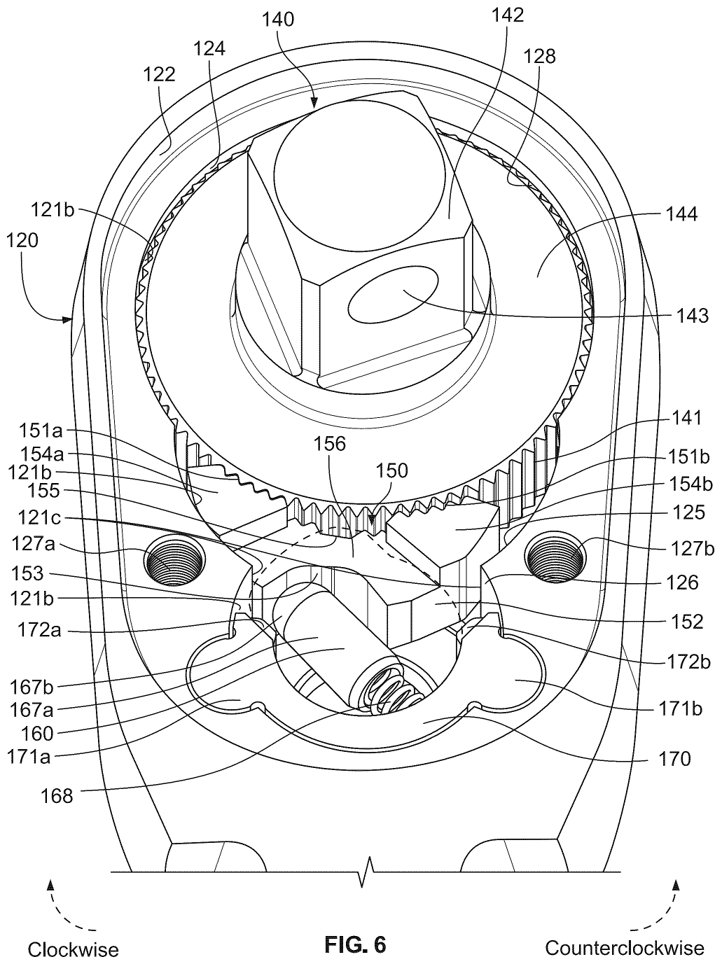

FIG. 3 illustrates a top perspective view of the head 120 (or head body) of the ratchet tool 100, according to embodiments. The head 120 includes a cavity 121, a lip 122, anchor pockets 123a, 123b, threaded holes 127a, 127b, a groove 128, and an aperture 129. The cavity 121 includes a front cavity portion 124 (or drive cavity portion), a middle cavity portion 125 (or pawl cavity portion), and a rear cavity portion 126. The anchor pockets 123a, 123b are located in the rear cavity portion 126 of the cavity 121. As shown in FIG. 4, the head aperture 129 receives a portion of the switch 160. In the embodiment shown in FIG. 4, the front cavity portion 124, the middle cavity portion 125, and the rear cavity portion 126 of the cavity 121 are at least partially distinguished from each other by ridges 121c on sidewall 121b extending from a bottom surface 121a of the cavity 121, although they need not be so distinguished. As shown in FIG. 6, the front cavity portion 124 receives at least a portion of the ratchet gear 140. The middle cavity portion 125 receives at least a portion of a pawl 150. The rear cavity portion 126 receives at least a portion of a sleeve 170 and at least a portion of the switch 160. Together, the head cavity middle portion 125 and the head cavity rear portion 126 is referred to as an actuator cavity portion. As shown in FIG. 4, the anchor pockets 123a, 123b are configured to receive corresponding anchors 171a, 171b on the sleeve 170 to anchor the sleeve 170 to the head 120.

FIG. 4 illustrates an exploded view of a portion of the ratchet tool 100, according to embodiments. In addition to the components mentioned above with respect to FIGS. 1-3 (the handle 110, the head 120, the cover plate 130, the ratchet gear 140, the switch 160, and the fasteners 101a, 101b), the ratchet tool 100 further includes the pawl 150, the sleeve 170, a retaining clip 180, a spacer 190, fasteners 101a, 101b, an O-ring 102, a biasing member 166, and a gasket 105. An actuator includes the pawl 150 and the switch 160. These components and the features thereon are further described below.

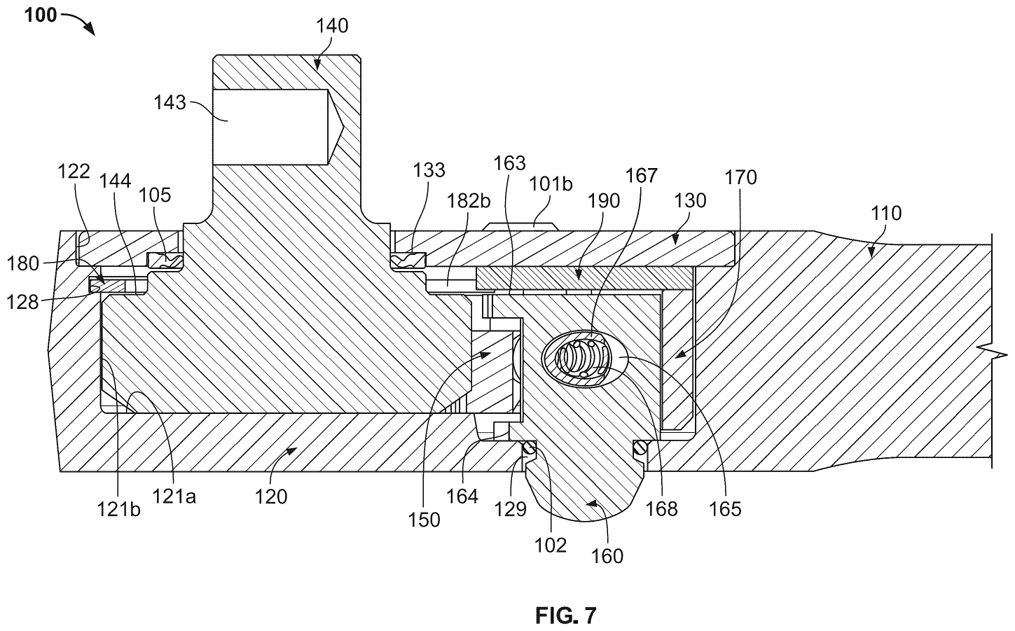

As shown in FIG. 4, the cover plate 130 includes a ratchet gear aperture 131 and fastener apertures 132a, 132b. The cover plate 130 rests on the cavity lip 122. The cover plate 130 is fastened (e.g., bolted) to the head 120 via the fasteners 101a, 101b. After passing through the cover plate fastener apertures 132a, 132b, the fasteners 101a, 101b are secured to the head 120 in the head threaded holes 127a, 127b, thereby securing or bolting the cover plate 130 to the head 120. When the cover plate 130 is bolted to the head 120, it can be referred to as a bolted cover plate 130. When the cover plate 130 is secured to the head 120, a portion of the ratchet gear 140 passes through the ratchet gear aperture 131. The gasket 105 is seated in a gasket recess 133 on the reverse side of the cover plate 130, as can be seen in FIG. 7. The gasket 105 substantially prevents contaminants (e.g., liquids or debris) from penetrating into the assembly of the ratchet tool 100.

As shown in FIGS. 4. 6, and 7, the ratchet gear 140 is received by the cavity 121, for example in the front cavity portion 124 of the cavity 121 (or drive cavity portion). The ratchet gear 140 is rotatable about an axis located within the front portion 124 of the cavity 121. This axis extends in a vertical dimension, and references to “vertical” herein are with respect to this dimension. Further, “upward” refers to the direction along the vertical dimension extending away from the bottom base of the cavity 121. The ratchet gear 140 includes a plurality of ratchet gear teeth 141, a drive member 142, and a recess 143. The ratchet gear 140 may be a single integrated piece. The drive member 142 engages with an accessory, such as a socket or an extension. As shown, the drive member 142 has a substantially square shape, but may also have a rectangular or other shape. As shown, the drive member 142 may optionally include a ball detent operable to engage with a conventional socket, such that the socket is additionally secured to the drive member 142 during operation of the ratchet tool 100 on a work piece (a piece external to the ratchet tool 100, such as the head of a bolt). The ratchet gear teeth 141 are circumferentially arranged on the ratchet gear 140. The ratchet gear teeth 141 engage with a plurality of corresponding pawl teeth 151 on the pawl 150, as will be further explained. The ratchet gear 140 further includes a shelf 144 having a horizontal orientation. The shelf 144 is arranged above the ratchet gear teeth 141. At least a portion of the shelf 144 is configured to interface with at least a portion of the clip 180, as will be further explained.

The sleeve 170 includes a body that has at least a partially circumferential shape and at least partially surrounds the switch 160 (as shown in FIGS. 4 and 6). The anchor pockets 123a, 123b in the cavity 121 of the head 120 are configured to receive anchors 171a, 171b of the sleeve 170. As such, the sleeve 170 stabilizes the switch 160 within the cavity 121 of the head 120, and specifically, at least partially within the rear cavity portion 126 of the cavity 121. The sleeve 170 further includes limiters 172a, 172b disposed on opposite ends of the body that limit rotation of the switch 160 in a clockwise or counter-clockwise direction. It is to be understood that the present disclosure contemplates the ratchet tool 100 that does not include the sleeve 170.

The switch 160 includes a body 162, the lever 161, a first ledge 163, a second ledge 164, and a bore 165. The switch 160 is rotatably disposed through the switch aperture 129 in the head 120, which is located underneath the rear cavity portion 126 of the cavity 121. The lever 161 extends through the head 120 below the cavity 121 via the switch aperture 129, as can be seen in FIGS. 2 and 4. The O-ring 102 is positioned in a recess in the switch 160 and adjacent the sidewall of the switch aperture 129 (see FIG. 7), and the O-ring 102 creates a barrier that inhibits debris particles or moisture from flowing into the cavity 121 of the head 120. The first ledge 163 extends away, or laterally, from the switch body 162. The second ledge 164 extends away, or laterally, from the switch body 162. As will be further described, a portion of the pawl 150 is received between the first ledge 163 and the second ledge 164, thereby limiting upward and downward movement of the pawl 150 along the vertical dimension when the switch 160 is rotated clockwise or counter-clockwise. The bore 165 extends at least partially into the switch body 162. The first ledge 163 is positioned above the bore 165, and the second ledge 164 is positioned below the bore 165.

The user interacts with the switch 160 via the switch lever 161. The user rotates the switch 160, via the lever 161, either clockwise or counterclockwise with respect to the vertical dimension, to move the pawl 150 to engage with the ratchet gear 140 in different arrangements to select either clockwise ratcheting or counterclockwise ratcheting. The bore 165 at least partially receives the biasing member 166 that includes a pin 167 and a spring 168. The pin 167 includes a body 167a and a head 167b, wherein the head 167b includes a non-planar surface operable to contact the pawl 150. The biasing member 166 defines a longitudinal axis that intersects a midpoint of the non-planar surface of the pin head 167b. The biasing member 166 uses elastic potential energy, i.e., a biasing force generated by the compression of the spring 168, to push the pin 167 into engagement with a rear surface 152 (as shown, a notch 153 therein) of the pawl 150, thereby pushing the pawl 150 against the ratchet gear 140.

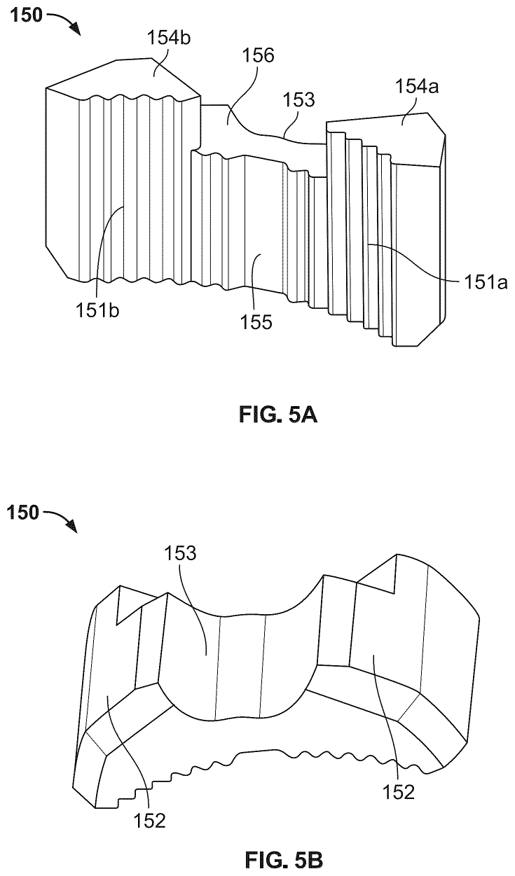

As shown in FIGS. 5A and 5B, the pawl 150 includes a front surface 155 having two sets of teeth 151a, 151b, the rear surface 152 having the notch 153, and two extended portions 154a, 154b on opposite ends of the pawl 150. In the embodiment shown in FIG. 6, the first ledge 163 of the switch 160 (shown with a broken line) overlaps the recessed portion 156 of the pawl 150 between the extended portions 154a, 154b such that the switch 160 does not rest on, or interfere with, the pawl 150. The second ledge 164 is positioned below the pawl 150, such that vertical movement of the pawl 150 is constrained by the first ledge 163 and the second ledge 164. The first set of pawl teeth 151a and the second set of pawl teeth 151b are operable to selectively engage the ratchet gear teeth 141 to limit rotation of the ratchet gear 140 in either a first rotational direction (clockwise) or a second rotational direction (counterclockwise).

As shown in FIG. 6, the pin head 167b of the biasing member 166 is operable to contact and engage with a first region of the notch 153 in the rear surface 152 of the pawl 150. When the pin head 167b engages with the first region of the notch 153, the first set of teeth 151a of the pawl 150 engage with the ratchet gear teeth 141 of the ratchet gear 140, and the second set of teeth 151b of the pawl 150 disengage with the ratchet gear teeth 141 of the ratchet gear 140. This configuration allows the ratchet tool 100 to ratchet in a counterclockwise direction.

The ratcheting direction of the ratchet tool 100 can be switched to a clockwise direction. Rotating the switch 160 causes the pin head 167b of the biasing member 166 to engage in a different, complimentary region of the notch 153, thereby causing the second set of teeth 151b to engage with the ratchet gear teeth 141, and causing the first set of teeth 151a to disengage with the ratchet gear teeth 141. This configuration allows the ratchet tool 100 to ratchet in a clockwise direction. The user can toggle between the clockwise and counterclockwise ratcheting configurations by moving or rotating the switch lever 161, thereby changing the orientation of the biasing member 166.

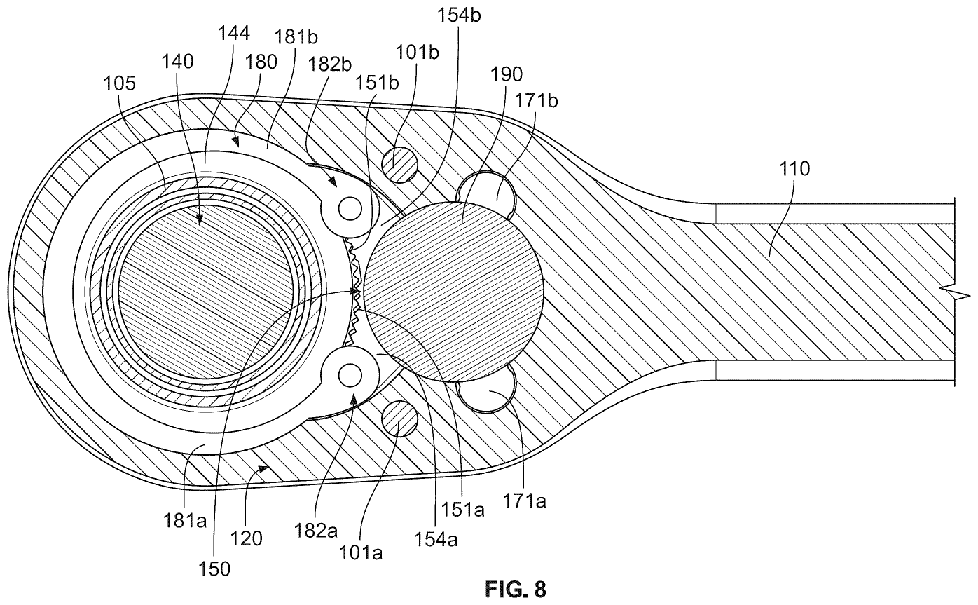

As shown in FIGS. 4, 7, and 8, the retaining clip 180 includes lug arms 181a, 181b extending circumferentially around a portion of the ratchet gear 140. The lug arms 181a, 181b keep the pawl 150 in alignment with the ratchet gear 140 and the switch 160. The lug arms 181a, 181b also prevent the pawl 150 from sticking to the ratchet gear 140, which may cause the ratchet gear 140 to jam, slip, or cause the switch 160 to change directions undesirably. The lug arms 181a, 181b each terminate with a lug 182a, 182b. Each lug 182a, 182b are wider than other portions of the corresponding lug arms 181a, 181b. The lugs shown 182a, 182b each have a generally circular profile having a hole in the middle. The lugs 182a, 182b include portions extending over portions of the ratchet gear 140 and the pawl 150. The lugs 182a, 182b assist in preventing movement between the ratchet gear 140, the pawl 150, and/or the switch 160 that may cause the ratchet gear 140 incapable of engaging with the pawl 150 and/or vice versa. Additionally, movement between the pawl 150 and the switch 160 may cause the user to be unable to change ratcheting configurations from clockwise to counterclockwise and vice versa. The lugs 182a, 182b of the retaining clip 180 keep the ratchet gear 140, the pawl 150 and the switch 160 positioned in the cavity 121 for the ratcheting tool 100 to be more effective for a longer period of time. The retaining clip 180 keeps the ratchet gear 140 and the pawl 150 in desired positions, which are the more expensive and critical to strength components of the ratchet tool 100. The retaining clip 180 is formed from or includes a material such as high carbon steel that provides high strength to resist loads and high hardness to resist wear from rotation experiences between the ratchet gear 140 and/or the pawl 150.

At least a portion of the retaining clip 180 is received by the groove 128 in the head 120. The groove 128 is horizontally arranged in the head 120, and the groove 128 is arranged in the front cavity portion 124 in the head 120, proximate the ratchet gear 140. When the retaining clip 180 is received by the groove 128, the retaining clip 180 is arranged above the shelf 144 of the ratchet gear 140. When the ratchet tool 100 is not in use, there may be a gap between the shelf 144 and the retaining clip 180. Furthermore, the lugs 182a, 182b are disposed above corresponding extended portions 154a, 154b of the pawl 150. There may be a space between the top surfaces of the extended portions 154a, 154b and the corresponding lugs 182a, 182b. The lugs 182a, 182b inhibit undue vertical movement of the pawl 150 during use of the ratchet tool 100 when the extended portions 154a, 154b come into contact with the lugs 182a, 182b.

Further, if during use, the ratchet gear 140 is torqued or twisted, such that a portion of the shelf 144 moves upwardly in the cavity 121, the shelf 144 (or the edge of the shelf 144 extending towards the ratchet teeth 141) engages with the retaining clip 180. This engagement tends to inhibit the ratchet gear 140 from twisting more, thereby inhibiting the contacting portion of the shelf 144 from moving higher in the cavity 121. Further, if the twisting of the ratchet gear 140 causes a portion of the retaining clip 180 to rise, that portion of the retaining clip 180 can contact the cover plate 130 if there is sufficient twisting of the ratchet gear 140 and the retaining clip 180. The contact between the retaining clip 180 and the cover plate prevents further twisting of the retaining clip 180 and the ratchet gear 140, such that the retaining clip 180 and the ratchet gear shelf 144 have a maximum height (not higher than the cover plate 130). The retaining clip 180 may only contact the underside of the cover plate 130 when under extreme stress, potentially beyond the rupturing strength of the retaining clip 180. Contact between the retaining clip 180 and the cover plate 130 may transfer stress and force to the cover plate 130. The transfer of stress and force from the retaining clip 180 to the cover plate 130 may prevent the retaining clip 180 from rupturing.

In the embodiment shown in FIGS. 4, 7, and 8, the spacer 190 is positioned below the cover plate 130. The upper surface of the spacer 190 contacts a lower surface of the cover plate 130. The spacer 190 is further positioned 190 above the switch 160, above the sleeve 170, and above a portion of the pawl 150, including above portions of the extension portions 154a, 154b of the pawl 150. The lower surface of the spacer 190 is adjacent to the upper surface of the sleeve 170. There is a gap between the lower surface of the spacer 190 and the upper surface of the switch 160. There is a gap between the lower surface of the spacer 190 and portions of the extension portions 154a, 154b of the pawl 150. The positioning of the spacer 190 prevents excess movement between components located in the ratchet head 120. However, the spacer 190 may contact some of the components in the ratchet head as a result of permissible movement between components. Because the cover plate 130 is secured to the head 120 and cannot move vertically, the spacer 190 has limited vertical movement (or no vertical movement). Because of this, the spacer 190 prevents undue vertical movement of the sleeve 170, switch 160, and/or pawl 150. Further, the switch 160 and pawl 150 can still move or rotate to function as described above. Further, the contact between the lower surface of the spacer 190 and the upper surface of the sleeve 170 prevents downward movement of the spacer 190. The spacer 190 allows for thickness variations in the head 120 and maintain the position of components that are not critical to strength, such as the switch 160, the pawl 150, the pin 167, and the spring 168. The retaining clip 180 placed below the pawl 150 does not provide any additional strength against gear tiling. The spacer 190 below the pawl 150 defeats the purpose of including the spacer 190 because a new switch lever 161 to keep the pin 167 contacting the correct spot on the pawl 150 is required. Placing the spacer 190 above the pawl 150 results in case of manufacturing. The switch lever 161 of the switch 160 would not be capable of being assembled through the switch aperture 129 if the spacer 190 was placed below the pawl 150.

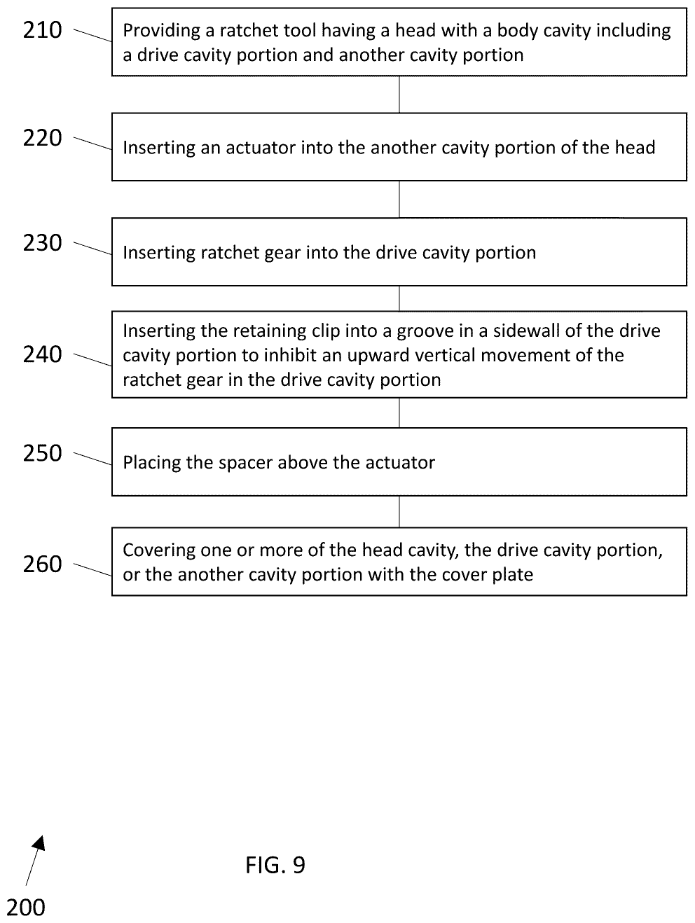

FIG. 9 is a flowchart 200 for a method of assembling the ratchet tool 100, according to embodiments. The flowchart 200 is described with respect to the ratchet tool 100, but is not so limited. The steps of flowchart 200 can sequence in a different order or some steps could be omitted. Steps could be performed simultaneously or combined into one step.

At step 210, the ratchet tool 100 is provided having a head 120 having a body cavity including a drive cavity portion 124 and a cavity portion 125. At step 220, the ratchet gear 140 is inserted into the drive cavity portion 124 of the head 120. At step 230, an actuator (in this embodiment, the pawl 150) is inserted into the cavity portion 125 of the head 120. At step 240, the retaining clip 180 is received in the groove 128 in a sidewall of the drive cavity portion 124 of the head 120 to inhibit an upward vertical movement of the ratchet gear 140 in the drive cavity portion 124. An inner portion of the retaining clip 180 can be disposed above the shelf 144 of the ratchet gear 140. At step 250, the spacer 190 is placed above the actuator (in this embodiment, the pawl 150). The spacer 190 and the retaining clip 180 can be arranged to inhibit an upward vertical movement of one or both of the pawl 150 or the switch 160. At step 260, one or more of the head cavity 121, the drive cavity portion 124, or the cavity portion 125 are covered with the cover plate 130.

PARTS LIST:

| | |
|---|---|
| 100 | Ratchet tool |
| 101a | Fastener |
| 101b | Fastener |
| 102 | O-ring |
| 105 | Gasket |
| 110 | Handle |
| 120 | Head |
| 121 | Cavity |
| 121a | Bottom surface of cavity |
| 121b | Sidewall of cavity |
| 121c | Ridges in cavity |
| 122 | Lip |
| 123a | Anchor pocket |
| 123b | Anchor pocket |
| 124 | Front portion of cavity |
| 125 | Middle portion of cavity |
| 126 | Rear portion of cavity |
| 127a | Threaded hole |
| 127b | Threaded hole |
| 128 | Groove |
| 129 | Switch aperture |
| 130 | Cover plate |
| 131 | Ratchet gear aperture |
| 132a | Fastener aperture |
| 132b | Fastener aperture |
| 140 | Ratchet gear |
| 141 | Ratchet gear teeth |
| 142 | Ratchet gear drive member |
| 143 | Ratchet gear recess |
| 144 | Ratchet gear shelf |
| 150 | Pawl |
| 151a | Pawl teeth (first set) |
| 151b | Pawl teeth (second set) |
| 152 | Pawl rear surface |
| 153 | Pawl rear surface notch |
| 154a | Pawl extended portion |
| 154b | Pawl extended portion |
| 155 | Pawl front surface |
| 156 | Pawl recessed portion |
| 160 | Switch |
| 161 | Switch lever |
| 162 | Body |
| 163 | First ledge |
| 164 | Second ledge |
| 165 | Bore |
| 166 | Biasing member |
| 167 | Pin |
| 167a | Pin body |
| 167b | Pin head |
| 168 | Spring |
| 170 | Sleeve |
| 171a | Anchor |
| 171b | Anchor |
| 172a | Limiter |
| 172b | Limiter |
| 180 | Retaining clip |
| 181a | Retaining clip lug arm |
| 181b | Retaining clip lug arm |
| 182a | Retaining clip lug |
| 182b | Retaining clip lug |
| 190 | Spacer |
| 200 | Flowchart |

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A ratchet tool comprising:
a head operably connected to a handle, the head including at least one cavity, wherein the at least one cavity receives and attaches to a cover plate;
a ratchet gear including a drive member for transmitting torque to a work piece;
a pawl disposed in the at least one cavity adjacent the ratchet gear, wherein the pawl is operable to engage with the ratchet gear in a first position to transmit torque through the ratchet gear and drive member in a first direction and a second position to transmit torque through the ratchet gear and drive member in a second direction;
a selector switch disposed in the at least one cavity and configured to move the pawl between the first position and the second position;
a spacer disposed in the at least one cavity; and
a retaining clip configured to inhibit an vertical movement of the ratchet gear in the at least one cavity.

2. The ratchet tool of claim 1, wherein the ratchet tool comprises a sleeve body disposed in the at least one cavity adjacent the selector switch and configured to retain the selector switch while allowing for movement of the selector switch.

3. The ratchet tool of claim 2, wherein the spacer is arranged below the cover plate and above at least one of the sleeve body or the selector switch.

4. The ratchet tool of claim 3, wherein the spacer is arranged below the cover plate and above both the sleeve body and the selector switch.

5. The ratchet tool of claim 3, wherein the retaining clip is further configured to inhibit a vertical motion of the pawl.

6. The ratchet tool of claim 5, wherein the retaining clip increases a side load strength of the ratchet tool.

7. The ratchet tool of claim 5, wherein the positioning of the retaining clip, the spacer, and the cover plate increases a maximum torque deliverable through the ratchet tool.

8. The ratchet tool of claim 5, wherein:
the retaining clip maintains a position of the ratchet gear along a drive axis; the switch is configured to inhibit a vertical movement of the pawl; and
the spacer is configured to inhibit a vertical movement of the switch.

9. A ratchet tool head assembly comprising:
a head body having first and second sides with a body cavity disposed in the first side, wherein the body cavity includes:
a drive cavity portion, wherein the drive cavity portion is configured to receive a ratchet gear such that the ratchet gear is rotatably disposed in the drive cavity portion, the ratchet gear including a drive post extending vertically from the ratchet gear;
an actuator cavity portion; and
a groove disposed in a sidewall of the drive cavity portion proximate to and parallel with the first side;
a retaining clip received by the groove, wherein the retaining clip is configured to inhibit a vertical movement of the ratchet gear, wherein the retaining clip includes a plurality of lug arms extending toward the actuator cavity portion;
a spacer received by the actuator cavity portion and configured to retain an actuator within the actuator cavity portion; and
a cover plate disposed on the first side of the head body, wherein the cover plate encloses the body cavity and includes an aperture, wherein the drive post of the ratchet gear projects vertically from the ratchet gear through the aperture.

10. The ratchet tool head assembly of claim 9, wherein the retaining clip increases a side load strength of the ratcheting tool head.

11. The ratchet tool head assembly of claim 10, wherein the retaining clip allows for increase of a torque delivered through the ratchet tool.

12. The ratchet tool head assembly of claim 11, wherein the ratchet tool further comprises a pawl disposed in a pawl cavity portion, the pawl being engageable with the ratchet gear to select a drive direction in which the ratchet gear rotates relative to the head body.

13. The ratchet tool head assembly of claim 12, wherein the lug arms of the retaining clip are configured to inhibit a vertical movement of the pawl.

14. A method of assembling a ratchet tool, comprising:
providing a ratchet tool head having a body cavity including a drive cavity portion and an actuator cavity portion;
inserting an actuator operable to engage the ratchet gear, wherein the actuator is inserted into the actuator cavity portion;
inserting a ratchet gear having a drive post into the drive cavity portion of the ratchet tool head;
engaging a retaining clip into a groove disposed in a sidewall of the drive cavity portion to inhibit a vertical movement of the ratchet gear in the drive cavity portion, wherein the retaining clip includes lug arms extending toward the actuator cavity portion;
placing a spacer above the actuator; and
covering one or more of the body cavity, the drive cavity portion, or the actuator cavity portion with a cover plate, wherein the drive post projects outwardly from the ratchet gear through an aperture disposed in the cover plate, the retaining clip being disposed between a portion of the ratchet gear and the cover plate.

15. The method of claim 14, further comprising engaging the retaining clip including disposing an inner portion of the retaining clip on top of a shelf of the ratchet gear.

16. The method of claim 14, wherein:
the actuator includes a pawl and a switch, wherein the pawl is disposed between the ratchet gear and the switch; and
wherein the method further comprises disposing the pawl below one or more of the lug arms of the retaining clip, and
wherein the lug arms of the retaining clip retain the pawl in a pawl cavity portion, and the pawl is adapted to be selectively engaged with the ratchet gear to select a drive direction in which torque is transmitted to a work piece.

17. The method of claim 16, wherein the switch includes a selector lever and the method further comprising disposing the selector lever on a bottom side of the ratchet tool head for a user to manipulate.

18. The method of claim 17, further comprising arranging the spacer and retaining clip to inhibit an vertical movement of one or both of the pawl or the switch.
